(19) United States
(12) Patent Application Publication
(10) Pub. No.: US 2010/0122661 A1
(43) Pub. Date: May 20, 2010

(54) HOUSING FOR A PET WASTE DISPOSAL SYSTEM

(75) Inventor: Barry Askinasi, Mt. Sinai, NY (US)

Correspondence Address: DARBY & DARBY P.C., P.O. BOX 770, Church Street Station, New York, NY, 10008-0770, US

(73) Assignee: Four Paws Products, Ltd., Hauppauge, NY (US)

(21) Appl. No.: 12/619,175

(22) Filed: Nov. 16, 2009

Related U.S. Application Data
(60) Provisional application No. 61/114,874, filed on Nov. 14, 2008.

(51) Int. Cl. A01K 29/00

(52) U.S. Cl. 119/161

(57) ABSTRACT

A housing for covering a digester system contains a hollow supporting structure on top of which is attached a catch basin via a hinge mechanism, wherein the catch basin has an inwardly concave shape so that rain or other water may be collected and directed through a passage to the digester system located directly below the catch basin.

### CROSS REFERENCE TO RELATED APPLICATION

This application claims the benefit of U.S. Provisional Application Ser. No. 61/114,874, filed on Nov. 14, 2008, which is hereby incorporated by reference in its entirety.

### FIELD OF THE INVENTION

The present invention relates to an improved housing design for a pet waste disposal system. More specifically, the housing for a pet waste disposal system contains a concave or similarly shaped cover piece for the collection and direction of water to the underground pet waste digester system so as to ensure proper operation of the system.

### BACKGROUND OF THE INVENTION

Various type of pet waste disposal systems have been around for many years. One such system is known as a digester. In a digester system, a site is chosen, such as a spot in the lawn or flower garden, for the disposal system. An extended hole is created in the ground typically using a post-hole digger. The hole may be any size but is typically a minimum of 8 inches in diameter and 48 inches deep. The deeper the hole, the more capacity for waste the digester will have. If, after filling with water, the soil around the hole collapses, the hole may be held open through the insertion of small stones or a PVC pipe drilled with small holes to help with drainage. Typically, an assembly is placed on top of the hole that provides closable access to the hole. The lid for the assembly typically has a flat top that seals the opening to keep debris or other inappropriate things from entering the hole, and to keep odors trapped in the hole. The lid for the assembly typically opens via a hinge.

To start the operation of the digester, several days worth of pet waste are added to the unit and a digester powder is added to the hole. The digester powder contains inactive bacterial and enzyme cultures. Next, the unit is filled with water, which activates the enzyme cultures to begin the digestion action. The operation of the digester is continuous as long as additional pet waste is added to the unit and enough water is maintained in the digester. Most of the enzymes will remain active above 40° F. and less than 110° F. if enough water is added. If the mass in the digester dries out, the digesting action will slow or effectively stop. Therefore, it is important to add water to the digester on a periodic basis.

It is in light of the foregoing that the current invention is contemplated.

### BRIEF DESCRIPTION OF THE DRAWINGS

The foregoing objects, aspects and vantages will be better understood from the following detailed description of the invention with respect to the drawings, in which:

FIG. 1 is a perspective view of the housing for a pet waste disposal system;

FIG. 2 is a side view of the housing for a pet waste disposal system;

FIG. 3 is a side view of the housing of a pet waste disposal system;

FIG. 4 is a top view of the housing for a pet waste disposal system; and

FIG. 5 is an exploded view of the housing for a pet waste disposal system.

### DETAILED DESCRIPTION OF THE INVENTION

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In one embodiment of the invention, a housing for covering a digester system contains a hollow supporting structure on top of which is attached a catch basin via a hinge mechanism. The catch basin may be moved from the closed position in which the basin covers an opening at the top of the support structure to an open position wherein access is provided to the interior of the support structure. The catch basin has an inwardly concave shape so that rain or other water may be collected and directed through a passage to the digester system located directly below the catch basin.

In another embodiment of the system, the passageway through the catch basin may consist of a series of passages. In yet another embodiment of the system, the passageway may include a one way valve.

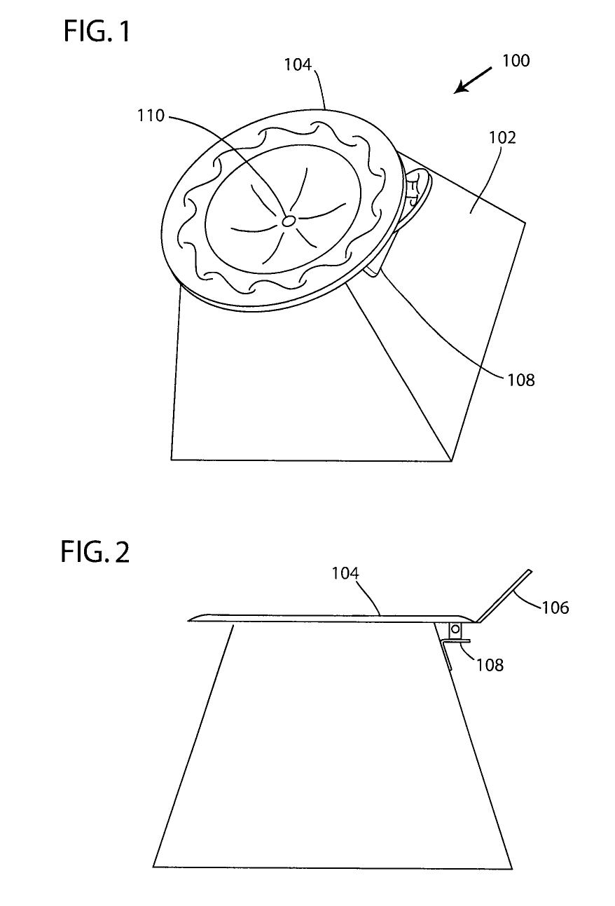

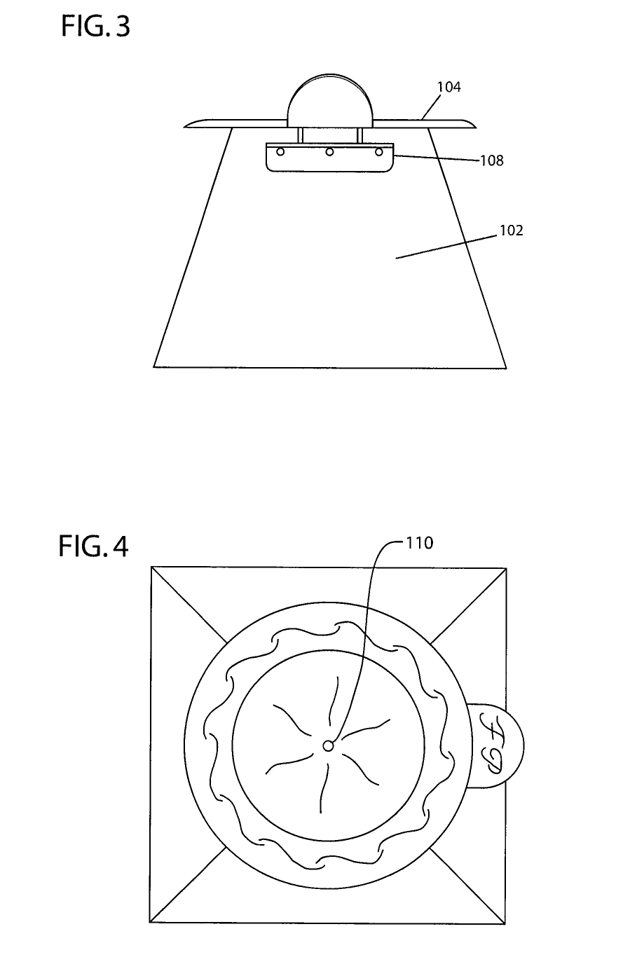

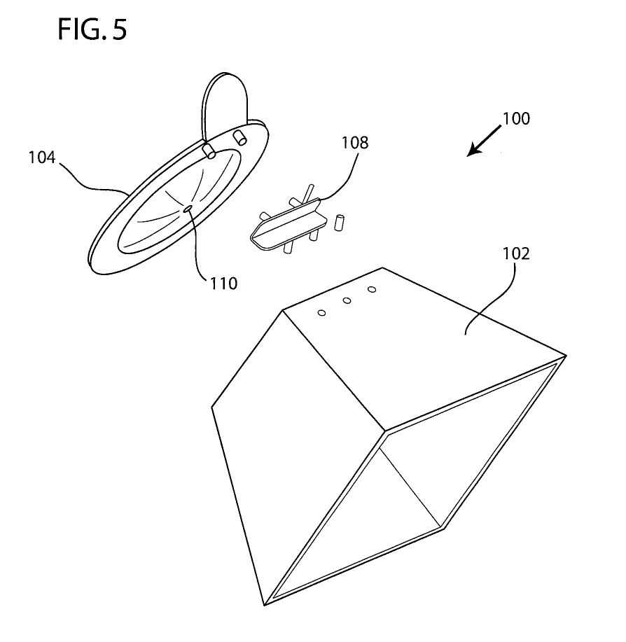

Pet waste disposal system housing 100 (FIG. 1) contains support structure 102 on top of which is mounted catch basin 104. Support structure 102 may be made of four panels connected together to form a pyramid-type structure. These panels may be made of any material and are typically made of a durable weather resistant wood, plastic or polymer material. The shape of the supporting structure may take any form and thus may be multi-sided, rounded or any other shape wide enough to cover a digester hole and capable of supporting catch basin 104. Catch basin 104 is connected to support structure 102 by hinge 108. Hinge 108 permits catch basin 104 to be moved from a closed position to an open position, enabling access to the interior of supporting structure 102. Catch basin 104 may be attached to support structure by any other actuatable mechanism.

Catch basin 104 may be circular and is in a generally concave shape that permits collection of rainwater, water from a sprinkler or the like when catch basin 104 is in the closed position. However, catch basin 104 may be any suitable shape to perform the function of catching water and directing it into the digester. In the center of catch basin 104 is passage 110 that permits drainage of catch basin 104 to the center of structural support 102. Passage 110 may be a single hole, multiple holes, slots or any other type of passage that permits water to drain through the catch basin into the digester system. Passage 110 may also contain a one way valve, a swing closure or the like that permits passage of water in catch basin 104, but keeps flies, insects, rodents or other unwanted things from entering the digester.

In operation of the pet waste disposal system, a hole would be dug into the ground, with the diameter of the hole being less than the smallest cross dimension of housing support 102. Next, housing 100 would be placed over the hole. Catch basin 104 would be moved into the open position and pet waste would be placed through housing 100 into the hole in the ground. Digester powder would be placed in the hole and the hole filled with water. Catch basin 104 would then be placed in the closed position. Because of the concave shape of catch basin 104, runoff rainwater or water from a sprinkler would be collected and drained into the digester system.

The advantage of the invention is that either no water or less water would be required to be added during the use of the system. This results in a lower probability of the system drying out and stopping operation. This invention would be particularly advantageous if used within the area serviced by a sprinkler system. Moreover, the catch basin may be increased in size from the dimensions shown in the drawings to catch more rainwater, water from a sprinkler system or the like.

1. A housing for covering a digester of a pet waste disposal system comprising:
a hollow support structure with an opening at a top end and an opening at a bottom end, the hollow support structure having an inner dimension at the bottom end larger than a radial cross sectional dimension of the digester;
a catch basin actuatably mounted to the top end of the hollow support structure, the catch basin being moveable between a closed position in which the catch basin substantially covers the opening at the top end of the hollow support structure and an open position that enables access to the interior of the hollow support structure and;
the catch basin being shaped to collect and direct water to the digester, the catch basin having a passageway between an upper surface and a lower surface of the catch basin.

2. The housing of claim 1 further comprising:
a one way valve within the passageway for allowing water to pass from the upper surface to the lower surface of the catch basin.

3. The housing of claim 1, wherein the passageway consists of multiple slots.

4. The housing of claim 1, wherein the catch basin has a peripheral dimension larger than the inner dimension of the bottom end of the hollow support structure.
